(19) United States
(12) Patent Application Publication
(10) Pub. No.: US 2003/0186159 A1
(43) Pub. Date: Oct. 2, 2003

(54) Composition and process for recovering coated polyester materials

(76) Inventor: John A. Schwartz JR., Spartanburg, SC (US)

Correspondence Address: Christina L. Mangelsen, Dority & Manning, Attorneys at Law, P.A., P.O. Box 1449, Greenville, SC, 29602, US

(21) Appl. No.: 10/109,557

(22) Filed: Mar. 28, 2002

(51) Int. Cl. G03C 7/30; G03C 7/42

(52) U.S. Cl. 430/256; 430/398; 430/260; 134/17; 134/29

(57) ABSTRACT

The present invention is directed to a process for separating polyester materials from various coating materials. In general, the process includes the steps of mixing polyester materials which have coatings adhered to the surface with an alkaline composition in a mixer. The alkaline composition contains a solution of a Group I alkaline compound and a Group II alkaline compound. The mixer imparts sufficient energy to the slurry to provide substantially complete, even coating of the polyester containing materials with the alkaline composition and cause separation of the coating materials from the surface of the polyester substrate. The mixture can be dried causing the remaining coating materials to form a dry powder mixed with the polyester substrate. After drying, the coating materials can be substantially removed from the polyester substrate by one or more dry separation techniques. After being subjected to the dry separation techniques, any remaining coating materials can be removed from the polyester substrate by a standard wash or rinse technique. Through the process of the present invention, polyester can be separated and recovered from waste materials such as those containing non-aqueous based silver emulsion coatings found in digitally printed X-ray films and the silver in such films can also be recovered. Through use of dry separation techniques, many environmental concerns and disposal problems encountered due to water treatment requirements of aqueous separation techniques can be alleviated.

### BACKGROUND OF THE INVENTION

Polyesters are polymeric materials made from the esterification of polybasic organic acids with polyhydric acids. Perhaps the most commonly made and used polyester is polyethylene terephthalate (PET), which can be manufactured by reacting terephthalic acid with ethylene glycol.

Polyesters are currently being used in increasing amounts in various applications. For instance, polyesters are commonly used to make all types of containers such as beverage and food containers, photographic films, X-ray films, magnetic recording tapes, electrical insulation, surgical aids such as synthetic arteries, fabrics and other textile products, and other numerous items.

Because polyesters can be remelted and reformed, many efforts are underway to recycle as much polyester as possible after use. Before polyesters can be recycled, however, it is necessary to separate the post-consumer polyesters from other products and materials that may be found mixed with or attached to the polyester. Unfortunately, many problems have been encountered in attempting to separate polyester from other waste materials. In particular, many prior art processes are not capable of efficiently or economically recovering polyester from some of the newer digital imaging processes used in producing various polyester products.

Mechanical recovery processes as used herein are washing processes used to strip specific binder and adhesive layers off polyester films without substantial reaction occurring between the polyester and the wash solution. For example, U.S. Pat. Nos. 5,286,463 and 5,366,998 both to Schwartz, Jr., both of which are incorporated herein by reference thereto, disclose a composition and process for removing adhesives, particularly polyvinylidene halide and polyvinyl halide based resins, from polyester films, such as photographic films. In one embodiment, the polyester films are mixed with a reducing sugar and a base to remove the adhesive polymeric resin from the film. An acid is then added to precipitate the resin, which can then be separated from the polyester film.

U.S. Pat. No. 4,602,046 to Buser et al. discloses a method for the recovery of polyester from scrap material such as photographic film having a polyester base and at least one layer of macromolecular organic polymer. Specifically, scrap material is cut or chopped into small individual pieces or flakes and treated in a caustic alkaline solution at a solids level of at least 25% by volume and under conditions of high shear. The organic polymer coating material is removed from the polyester flakes. The polyester flakes are then separated from the polymer coating material by filtration or centrifugation, rinsed in water, and dried. The recovered polyester flakes can be used as a feed stock for making films, bottles or other polyester articles.

A method and apparatus for recovering silver and plastic from used film is also disclosed in U.S. Pat. No. 4,392,889 to Grout. In this method, the used film is first passed through a bath preferably comprising a hot caustic solution for precipitating silver layered on the film. The film then passes through a second bath of hot caustic until an adhesive sheet disposed on the film has been dissolved. Typically, the adhesive sheet is made of polyvinylidene chloride, which adheres the silver to the film. After a second caustic bath, the film is dried and available for use.

Other processes for recovering polyester from photographic films are disclosed in U.S. Pat. No. 3,928,253 to Thornton et al., U.S. Pat. No. 3,652,466 to Hittel et al., U.S. Pat. No. 3,647,422 to Wainer, and U.S. Pat. No. 3,873,314 to Woo et al.

As shown above, mechanical recovery processes have generally been limited to use with photographic films. In recycling the photographic films, silver is also recovered making the processes economically viable. These mechanical recovery processes, although very successful at removing many of the older, water-based emulsion coatings found on photographic films, have generally not been successful in removing other types of coatings from polyesters. For instance, known prior art processes have not proven capable of efficiently removing some of the vapor barrier coatings, inks, and newer silver emulsion coatings that can be applied to polyesters.

Because of the above noted deficiencies in prior art processes, large amounts of recyclable polyesters and coating materials are being scrapped and loaded into landfills or are being incinerated. Unfortunately, not only is the polyester not being reused, but the polyester materials are creating a waste management and disposal problem.

The process of the present invention is directed to improvements in processes for recycling coated polyesters.

### SUMMARY OF THE INVENTION

In general, the present invention is directed to a process for removing coating materials adhered to a polyester substrate. In one embodiment, the polyester substrate can be a photographic or X-ray film coated with a silver-emulsion. In this particular embodiment, the process of the present invention can also include recovery of the silver from the separated coating materials. In another embodiment, the process of the present invention is directed to the removal of digital imaging coatings from polyester substrates. The present invention is also directed to the alkaline composition which can be used in the separation process.

In one embodiment, the process of the present invention includes combining polyester materials adhered to a coating with an alkaline composition to form a slurry. The polyester materials and the alkaline composition are combined such that the polyester is coated by the composition, such as, for example, in a high energy mixer. Energy is then added to the slurry to promote the separation of the coating materials from the surface of the polyester substrate and/or to degrade the coating materials into a removable form. In one embodiment, suitable energy can be added to the mixture due to the action of the high energy mixer alone to promote this separation and degradation. Additionally, however, if desired, the mixer can also be heated to expedite the separation process. For example, the mixer can be heated to an internal temperature of about 200° F. to expedite the separation process.

After the polyester substrate and the coating materials have become separated from each other, the separated coating materials can be removed from the substrate. In one embodiment, this can be accomplished through the use of one or more dry separation techniques. In this case, once separation is complete, the mixture can be dried, either in the mixer or alternatively in a separate dryer. Once dry, the mixture can be processed with one or more dry separation techniques, such as for example a cyclone or passing the dried mixture over a vibrating screen. In general, between about 50% and about 90% of the coating materials can be removed from the polyester substrate in the dry separation processes of the present invention.

After the dry separation of at least a portion of the coating materials from the substrate, any remaining coating materials still mixed with the polyester substrate can be removed in any suitable known washing or rinsing operation. For example, the polyester substrate can be washed with water alone or alternatively with a weak alkaline solution of about 1% sodium hydroxide.

In one embodiment of the present invention, the coating materials adhered to the polyester substrate can include silver-emulsion coatings found in photographic and X-ray films. In such an embodiment, the process can also include the recovery of the silver from the separated coating materials. For example, during the dry separation processes, the dried coating materials including silver can be collected. These dried materials can then be roasted or smelted in order to recover silver from the separated coating materials.

The alkaline composition used in the process of the present invention is a solution of a combination of a Group I alkaline compound and a Group II alkaline compound. In one embodiment, the composition can include water in an amount from about 8% to about 100% by weight of the polyester materials to be processed, a Group I alkaline compound in an amount from about 0.3% to about 1.0% by weight of the coated polyester materials, and a Group II alkaline compound in an amount from about 0.4% to about 0.55% by weight of the coated polyester materials.

The Group I alkaline compound and the Group II alkaline compound can be any suitable Group I alkaline compound and Group II alkaline compound. For example, the Group I alkaline compound can be a Group I metal hydroxide compound, such as sodium hydroxide or potassium hydroxide. Alternatively, the Group I alkaline compound can be a Group I metal carbonate compound, such as sodium carbonate or potassium carbonate, for example. Specifically, a Group I metal hydroxide compound can be added to the alkaline composition in an amount from about 0.40% to about 0.55% by weight of the coated polyester material. A Group I metal carbonate compound can be added to the alkaline composition in an amount from about 0.55% to about 0.70% by weight of the coated polyester materials to be processed.

Possible examples of the Group I alkaline compound can include sodium hydroxide, sodium carbonate, potassium hydroxide, and potassium carbonate. Possible example of the Group II alkaline compound can include calcium hydroxide, calcium carbonate, magnesium carbonate, and magnesium hydroxide. In one possible embodiment of the present invention, the Group I alkaline compound can be either sodium hydroxide or sodium carbonate and the Group II alkaline compound can be either calcium hydroxide or calcium carbonate. Alternatively, the Group I alkaline compound can be either sodium hydroxide or sodium carbonate, and the Group II alkaline compound can be calcium hydroxide.

### DETAILED DESCRIPTION OF PREFERRED EMBODIMENTS

The present invention is generally directed to a process for separating and recovering polyesters from various coating materials. For instance, through the process of the present invention, polyesters can be separated and recovered from various coatings including silver emulsion coatings, vapor barrier coatings, inks, and saran coatings. During the process, the coated polyester materials are mixed with an alkaline composition such that coating materials adhered to the polyester become separated from the polyester substrate. Coating materials can degrade or be chemically converted during the process into a form that is easily separable from the polyester. Once separated from the polyester, the coating materials can be further degraded while the materials are being dried, if desired. Specifically, solvents and liquids contained within the polyester/coatings mixture can be volatilized leaving behind some relatively smaller sized dry impurities mixed with the polyester substrate. A substantial portion of the dry coating materials can then be physically removed from the polyester substrate through one or more suitable dry separation techniques prior to final washing or rinsing of the polyester substrate to remove any remaining impurities. If desired, the separated coating materials can then be further processed to recover desirable materials, such as silver.

As used herein, a polyester is defined as an esterification or reaction product between a polybasic organic acid and a polyol. It is believed that any known polyester or copolyester may be used in the process of the present invention. The process of the present invention is particularly directed to a class of polyesters referred to herein as polyol polyterephthalates, in which terephthalic acid serves as the polybasic organic acid.

As used herein, a polybasic organic acid refers to any organic acid having two or more carboxyl groups (—COOH). Most polyesters are derived from dibasic acids or, in other words, from dicarboxylic acids. Polybasic acids can have a linear or a cyclic conformation. Examples of linear polybasic acids that can be used to make polyesters include the aliphatic dicarboxylic acids. In particular the aliphatic dicarboxylic acids having up to ten carbon atoms in their chains can be used. These acids include adipic acid, glutaric acid, succinic acid, malonic acid, oxalic acid, pimelic acid, suberic acid, azelaic acid, sebacic acid, maleic acid, and fumaric acid.

Cyclic polybasic organic acids, on the other hand, include the carbocyclic dicarboxylic acids. These acids are known as phthalic acid, isophthalic acid, and terephthalic acid. In particular, terephthalic acid is used to make polyethylene terephthalate, which is perhaps the most commercially available polyester.

As described above, a polybasic organic acid is combined with a polyol to produce a polyester. Polyols are compounds that contain at least two hydroxyl groups. Many polyesters are synthesized using a polyol that contains two hydroxyl groups, which are referred to as diols. Diols are normally prepared from an alkene by the net addition of two hydroxy groups to the double carbon bond in a method known as hydroxylation. Polyols are commonly referred to as glycols and polyhydric alcohols. Examples of polyols used to make polyesters include ethylene glycol, propylene glycol, butylene glycol, and cyclohexane dimethanol.

For exemplary purposes, the following table contains a nonexhaustive list of commercially available polyesters that may be recovered and recycled according to the present invention. For each polyester, the corresponding polybasic organic acid and polyol are provided.

| | POLYBASIC | |
|---|---|---|
| POLYESTER | ORGANIC ACID | DIOL |
| Polyethylene | Terephthalic Acid | Ethylene Glycol |
| Terephthalate | | |
| Polybutylene | Terephthalic Acid | Butylene Glycol |
| Terephthalate | | |
| PETG Copolyester | Terephthalic Acid | Cyclohexane- |
| | | dimethanol and |
| | | Ethylene Glycol |
| PBTG Copolyester | Terephthalic Acid | Cyclohexane- |
| | | dimethanol |
| | | and |
| | | Butylene Glycol |
| Polycyclohexane- | Terephthalic Acid | Cyclohexane- |
| dimethanol | dimethanol | |
| Terephthalate | | |
| PEN Polyester | Napthalene Dicarboxylic | Ethylene Glycol |
| | Acid | |

Recent advances in the digital imaging technologies have led to new polymer based inks and non-aqueous based emulsions which can be coated onto polyester materials in a digital imaging process. For example, Kodak DryView™ imaging systems have been used to prepare digital images on various polyester-based substrate materials. The coating materials used in such imaging systems have often proven resistant to the separation processes and alkaline compositions known in mechanical recovery processes of the past. As a result, the inventor has developed alkaline compositions which, when used in the process of the present invention, can substantially remove not only previously known coating materials from polyester substrates, but can also separate coating materials and impurities, such as certain silver emulsion barriers found in digital imaging technologies, which have proven resistant to previously known separation techniques.

The process of the present invention is also capable of removing other coatings adhered to polyester as well. In particular, the process of the present invention is capable of removing vapor barrier coatings and screen printed labels from polyester containers. Vapor barrier coatings are typically applied to beverage containers in order to prevent carbon dioxide escape when containing carbonated beverages and/or prevent oxygen incursion when containing liquids that could spoil in the presence of oxygen. Vapor barrier coatings can be made from saran, polyvinylidene chloride, or an acrylic. Screen printed labels, on the other hand, generally refer to inks that are directly applied to polyester containers, such as beverage containers. For instance, many soft drink containers are typically labeled with an epoxy based ink. In the past, many problems have been encountered in attempting to separate the polyester substrate from such coatings and inks.

In general, the process of the present invention includes first combining coated polyester materials with an alkaline composition in a mixer. The mixing process can evenly coat the polyester materials with the alkaline composition and can add enough energy to the mixture to cause the polyester materials to be scrubbed, or washed, by the alkaline composition, freeing the coating materials. The combination of adding an alkaline composition to the materials and adding energy can cause the coating materials to degrade or otherwise to be converted into a form that is easily separable from the polyester. If desired, once the polyester substrate is separated from the coating materials, the mixture can be dried. The bulk of the dry coating materials and any other impurities present in the mixture can then be removed from the polyester substrate through one or more dry separation techniques. A final wash of the polyester substrate with water or a weak caustic solution can remove any remaining impurities.

Use of one or more dry separation techniques to remove the polyester substrate from the coating materials can provide many benefits to the process of the present invention. For example, dry separation techniques can alleviate many environmental concerns and disposal problems encountered in the past due to water treatment requirements of wash water when aqueous separation techniques are employed. Additionally, in those embodiments wherein the separated materials include economically viable materials, such as silver, the dried separated materials, once removed from the polyester, are already in suitable form for roasting, smelting, or otherwise processing in order to recover any desired materials from the separated coating materials.

The process of the present invention can run continuously or can be set up as a batch system. Practically any material containing a polyester can be processed by the present invention including but not limited to, for example, photographic and X-ray films, recording tapes, beverage and food containers, insulation materials, and textile fibers and other products. However, the present invention is particularly well suited to recycling polyester materials which have had a coating adhered to them, such as photographic and X-ray films, for example. Through the process of the present invention, polyesters can be separated, recovered and reused from post consumer waste, even when a polyester substrate is coated with certain non-aqueous based inks or emulsion coatings which have proven resistant to recycling techniques of the past. In addition, desired coating materials themselves can be recovered and recycled through the present process. Such materials are currently being disposed of in landfills or are being incinerated after use due to a lack of an economical process that can recover the materials.

Prior to being contacted with the alkaline composition, the coated polyester materials can be, if desired, chopped or ground into a particular size. Sizing of the materials is done solely for the purpose of facilitating handling. Generally speaking, the larger the size of the materials and the less surface area to volume ratio, the less chance of saponification, or hydolization, of the polyester occurring later in the process. Consequently, smaller dimensions should be avoided and the size of the materials should be left as large as practicable. However, it should be understood that all different sizes and shapes of material may be used within the process of the present invention and no one size or shape is required. In general, the term polyester flakes as used in this disclosure refers to polyester materials which have been chopped or ground prior to being contacted with the alkaline composition.

Also prior to being combined with the alkaline composition, the materials containing the polyester can be immersed in water or some other fluid in order to separate any less dense or lighter materials from the heavier materials containing the polyester. More particularly, it is known that polyester sinks in water while paper products and other polymers, such as polyolefins, are water buoyant. Thus, the lighter materials can be easily separated from the heavier materials when contacted with a fluid. Subjecting the materials to a sink/float separation step prior to contacting the materials with the alkaline composition not only reduces the quantity of materials being processed but also cleans the surface of the materials prior to further processing.

After being sized and subjected to a sink/float separation, if desired, the polyester containing materials can be combined and mixed with an alkaline composition to form a mixture. In general, the polyester materials are combined with the alkaline composition in an amount sufficient to completely coat the outside surface of the polyester and mixed sufficiently to promote the separation of the coating materials from the polyester without substantial saponification of the polyester materials occurring. Generally, coating materials can be degraded or converted in the presence of the alkaline composition and energy into a form that is easily separable from the polyester during the mixing operation.

In accordance with the present invention, an alkaline composition has been developed which can substantially remove adhered coating materials from polyester substrates. Generally, the alkaline composition of the present invention is a solution containing both a Group I alkaline compound and a Group II alkaline compound. For example, in one embodiment, equal amounts of sodium hydroxide and calcium hydroxide can be combined in an aqueous solution to form the alkaline composition of the present invention.

It is believed that any Group I alkaline compound can be used in the process of the present invention. For example, any sodium, potassium, or lithium alkaline compound can be used. Specific examples of possible Group I alkaline compounds suitable for use can include, but are not limited to, for example, sodium hydroxide, sodium carbonate, potassium hydroxide, and potassium carbonate.

Similarly, it is believed that any Group II alkaline compound can be used in the process of the present invention. Possible Group II alkaline compounds can include, but are not limited to, for example, calcium hydroxide, calcium carbonate, magnesium carbonate or magnesium hydroxide.

The amount and make-up of the alkaline composition added to the materials containing the polyester will depend upon the type and amount of impurities and contaminants coated onto the materials. Generally, the alkaline composition should be added only in an amount sufficient to separate the impurities from the polyester, so as to minimize the possibility of saponification of the polyester.

In general, the Group I alkaline compound can be added to the alkaline composition in an amount between about 0.30% and about 1.0% of the weight of the polyester materials to be contacted with the composition.

For example, in one embodiment of the present invention, a Group I alkaline compound can be used in preparing the alkaline composition which is a Group I metal hydroxide compound. Examples include sodium hydroxide or potassium hydroxide. In general, such a Group I alkaline compound can be added to the alkaline composition in an amount between about 0.40% and about 0.55% of the weight of the coated polyester material. More specifically, a Group I metal hydroxide can be added to the alkaline composition in an amount between about 0.42% and about 0.50% by weight of the polyester. In one embodiment, the Group I metal hydroxide compound can be added to the alkaline composition in an amount of about 0.44% by weight of the polyester material.

In an alternative embodiment, a Group I metal carbonate compound can be used in forming the alkaline composition. Examples of Group I metal carbonate compounds can include, for example, sodium carbonate or potassium carbonate. For example, a Group I metal carbonate compound can be added to the alkaline composition in an amount between about 0.55% and about 0.70% of the weight of the coated polyester material. More specifically, a Group I metal carbonate compound can be added to the alkaline composition in an amount between about 0.57% and about 0.65% of the weight of the polyester material. In one embodiment, a Group I metal carbonate compound can be added to the alkaline composition in an amount of about 0.59% by weight of the polyester materials.

In addition to a Group I alkaline compound, the composition of the present invention also contains a Group II alkaline compound. In general, any Group II alkaline compound can be added to the composition in an amount of from about 0.40% to about 0.55% of the weight of the coated polyester materials to be contacted by the composition. More specifically, the Group II alkaline compound can be added to the composition in an amount of from about 0.43% to about 0.50% of the weight of the polyester material. In one embodiment, the Group II alkaline compound can be added in an amount of about 0.44% by weight of the polyester materials.

In forming the solution, the Group I alkaline compound and the Group II alkaline compound can be dissolved in water. Water can be added to form the solution in any amount up to about a 1:1 ratio as compared to the weight of the polyester materials to be processed. Additional amounts of water in the solution, while not detrimental to the process, can be undesirable due, for example, to the additional energy requirements needed in drying the mixture once the coating materials and the polyester substrate have been separated. In general, the amount of water in the composition can be from about 8% to about 100% of the weight of the polyester materials to be processed. Specifically, the composition can contain water in an amount from about 20% to about 90% of the weight of the polyester materials. More specifically, the amount of water in the composition can be from about 50% to about 80% of the weight of the polyester materials to be contacted by the alkaline composition.

In general, enough water can be included in the composition so as to ensure both formation of the solution and complete coating of the polyester materials by the solution. Additionally, because energy will be added to the mixture during the separation process, it is desirable to include enough water in the composition to ensure separation of the coating materials from the polyester prior to evaporation of substantial amounts of water. As such, the minimum amount of water necessary in the composition can vary depending upon process conditions. For example, less water can be required in a sealed mixing system as compared to a vented mixing system, due to the lower rate of water evaporation in a sealed system. Additionally, if the polyester/alkaline composition mixture is heated during the separation process, it may be beneficial to add more water to the composition.

In one particular embodiment, various other agents, including wetting agents, rinse aids, coupling agents, emulsifiers, solvents, and anti-redeposition surfactants may be added to the composition to improve its effectiveness in the recovery process. The choice among the various agents employed in certain embodiments of the present composition is not necessarily critical to the functioning of the recovery process. It should be understood that, although certain specific agents are used in the following examples, these agents are merely exemplary and one of ordinary skill in the art could employ various other equivalent agents to achieve equivalent compositions.

The alkaline composition of the present invention, in addition to being suitable for removing various coatings from polyester materials, can also be used in other known recovery processes, such as chemical conversion processes, for example, for removing other types of impurities from polyester materials.

Preferably, the alkaline composition can be combined with the polyester materials so as to evenly coat the material surface. In some applications, the material surface can resist uniform coating due to surface tension interaction. In this situation, the alkaline solution has a tendency to “bead up” on the material surface.

Mixers such as those described in U.S. Pat. No. 4,320,979 to Lucke and U.S. Pat. No. 4,189,242 to Luke, which are herein incorporated in their entirety by reference thereto, describe various mixing techniques which have improved uniform coating of material surfaces. Such mixers are typical of high energy mixers which may be employed for coating of the polyester materials in the present process.

In one embodiment of the present invention a mixer can be utilized which imparts enough energy to the mixture so as to evenly coat the polyester materials with the alkaline composition as well as to promote the separation of the coating materials from the substrate within the mixer without the necessity of additional energy being added to the mixture. For example, in one possible embodiment, a mixer such as the Littleford Day FM-130 ploughshare type mixer can be utilized. This particular mixer is available from the Littleford Day Company of Florence, Ky. Besides a ploughshare type mixer, however, it should be understood that various other mixers can be used.

In accordance with the present invention, an amount of ground or chopped polyester material can be added to the mixer after any desired pretreatment processes have been performed, such as, for example, the floatation separation processes as previously discussed. The alkaline composition can then be added to the mixer with the polyester material.

The mixer can be operated at, for example, greater than 50 rpm, particularly greater than 70 rpm, and more particularly greater that about 80 rpm in order to substantially evenly coat the polyester material with the alkaline composition and promote separation of the coating materials from the polyester substrate. Though not required when a suitable high energy mixer is utilized, if desired, heat can also be added to the mixture in order to expedite the separation process. For example, in one embodiment of the present invention, at the above mixing rates, the polyester/alkaline composition mixture can be mixed for approximately 30 minutes at a temperature of about 200° F. in order to substantially separate all of the coating materials from the polyester. Heat can be added to the mixture by any suitable process. For example, heat can be provided to the mixture via a heated air flow through the mixer. Alternatively, the mixer can be heated externally. Heating the mixture may require additional water to be added to the alkaline composition, however, since, as previously discussed, excessive evaporation of water should be avoided prior to completion of the separation process.

One of the benefits of the process of the present invention is the limited amounts of reactants required. For example, when utilizing a high energy mixer, relatively small amounts of the Group I and Group II alkaline compounds are required to separate the coating materials from the polyester flakes. This is believed to be due to a combination of the thorough coating of the polyester materials and the high-energy mixing which promotes the separation process. Substantially all of the coating materials can be separated from the polyester substrate through the process of the present invention using relatively small amounts of reactants. In addition, limited amounts of reactants can also prevent saponification of the polyester substrate materials once the coatings have been removed from the substrate surface.

In past recovery techniques, once the coating materials were physically separated from the polyester substrate, it was common to separate the clean polyester from the coating materials using various washing and rinsing operations. Use of aqueous separation techniques can present difficulties with certain coating materials, however. For example, the water used for aqueous separation techniques can require extensive water treatment in order to meet desired water purification standards for waste water as well as to recover desired materials, such as silver, from the wash water.

Other difficulties have been encountered in removing the separated coating materials from the polyester substrate using aqueous separation techniques as well. For example, certain digital imaging technologies produce coatings and inks on polyester materials which can include non-aqueous based organic polymer materials. Often, when a mixture of polyester substrate and separated impurities containing a large amount of such organic polymer materials is contacted with an aqueous solution during liquid separation techniques, these polymer materials can congeal and form a thick, sticky coating on the polyester. These congealed impurities can be difficult to separate from the clean polyester substrate material. For example, when the coated polyester materials to be processed contain more than about 25% materials coated in a digital imaging system employing such polymer materials, the separated coating materials can be very difficult to remove using an aqueous separation technique.

As a result of these and other difficulties, one embodiment of the process of the present invention employs one or more dry separation techniques to remove at least a portion of the separated coating materials from the polyester substrate.

In one embodiment of the present invention, once the separation process is complete, the mixture can be dried prior to removal of the separated coating materials from the polyester substrate. For example, in one particular embodiment of the present invention, drying of the mixture can be implemented in the mixer itself. The mixture can be dried within the mixer in any suitable drying process. For example, the mixer can simply continue to run after the separation process is complete until all volatile substances have been evaporated. Alternatively, the drying process can be carried out in the mixer, but can be expedited by blowing air through the mixer, such a by use of an air sparge. Such an air flow can also be heated to further increase the drying rate of the materials. Depending on the amount of water in the alkaline composition, a drying air flow can continue throughout both the separation and drying processes, or alternatively, an air flow can begin in the mixer only after suitable time has passed to ensure completion of the separation process.

In an alternative embodiment, the mixture can be removed from the mixer while still wet and then dried in any suitable process.

As the mixture dries, those separated materials which are not volatized can form a dry powder mixed with the polyester substrate. This dry powder containing various contaminants and impurities can be separated from the polyester by any suitable means. For example, in one embodiment of the present invention, the mixture can be dried in the mixer using an air sparge. In this particular embodiment, the mixer can also be vented and include a solids trap in the vent, such as, for example, a filter or a bag house. The air flow from the air sparge can then dry the materials and also can pick up and carry some of the dried separated materials to the solids trap in the vent. These powdered, separated materials can then be collected from the trap.

In an alternative embodiment, the dried mixture can be removed from the mixer or dryer prior to removal of any of the separated coating materials from the polyester substrate. For example, the dried mixture can be removed from the mixer and sent through a cyclone in order to separate the polyester substrate from the dried coating materials. Alternatively, the dried mixture can be removed from the mixer or dryer and then vibrated over an appropriately sized screen such that the dried coating materials shake down and fall through the screen, leaving the larger polyester flakes behind.

A combination of drying techniques can also be used in the process of the present invention. For example, a portion of the dried materials can be removed from the polyester in the mixer using a vented air flow system. After removal from the mixer, the mixture can then be subjected to a second separation technique, such as a vibrating screen technique or a cyclone in order to remove additional dried materials from the polyester substrate. In general, the dry separation techniques of the present invention can remove from about 50% to about 90% of the coating materials from the polyester substrate.

The process of the present invention has been found to be particularly well suited to the recovery of polyester and coating materials which have been used in forming photographic and X-ray films. In particular, the dry separation techniques of the present invention can facilitate the recovery of silver used in production of these films. For example, after being removed from the polyester substrate through one or more dry separation techniques, the collected, powdered materials can be ready to be roasted or smelted in order to recover silver without any additional processing.

After being subjected to one or more dry separation techniques, the polyester substrate may still be mixed with some remaining dried contaminants. To remove any remaining impurities, it may be desirable to subject the polyester flakes to a final wash. For example, the polyester flakes can be subjected to a final water rinse under agitation. Because the bulk of the dried coating materials and impurities can be removed by one or more dry separation processes prior to such a wash, those problems encountered with aqueous separation techniques when large amounts of impurities are present, such as congealing of materials, or extreme water treatment requirements, for example, will no longer pose a serious problem in the process of the present invention.

In general, the polyester substrate flakes can be washed according to any conventional aqueous mechanical recovery process. For instance, after being subjected to one or more dry separation techniques, the materials containing the polyester can be mixed with a hot aqueous solution containing a surfactant or with a hot aqueous alkaline solution and washed. In one embodiment, the polyester materials can be mixed with a solution including about 1% by weight sodium hydroxide and about ½% by weight of a wetting agent. If desired, the mixture can be heated under agitation during the wash cycle. Washing the materials following dry separation can generally clean the polyester to at least about 99% purity and can dissolve and/or break apart any remaining impurities, such that they may be removed with the wash water, for example, over a screen.

In addition to separating polyester from any remaining impurities such as various coating materials, a final rinse or wash process can also separate the polyester from any larger impurities which have not already been removed in the dry separation techniques. For example, polyvinyl chloride or aluminum which has not previously been removed in the process can be removed in a flotation, rinse or wash separation process subsequent to the dry separation techniques of the present invention.

In summary, regardless of the impurities present, the process of the present invention includes contacting materials containing polyester with an alkaline composition, mixing the alkaline mixture and the polyester materials together such that the materials are substantially and evenly coated by the composition and separation of the coating materials or other impurities from the polyester occurs, drying the polyester/contaminants mixture, subjecting the mixture to one or more dry separation techniques, and then rinsing or washing the remaining polyester materials with a fluid. During washing, water buoyant contaminants can be separated from the polyester. Also, the water mixture can be passed through a screen in order to separate smaller sized impurities from the polyester.

The present invention may be better understood with reference to the following examples.

### Example 1

The following alkaline compositions were prepared according to the present invention

| | Mix 1 | Mix2 | Mix 3 | Mix 4 |
|---|---|---|---|---|
| Water (liters) | 7 | 7 | 7 | 7 |
| Caustic Soda (g) | 50 | | 50 | |
| Soda Ash (g) | | 70 | | 67 |
| Lime (g) | 50 | 50 | 50 | 50 |
| Hexyl Carbitol (g)** | | | 30 | 30 |
| Ethoxylated alcohol (g) | | | 30 | 30 |
| Tetramethyl | | | 5 | 5 |
| ammonium chloride (g) | | | | |

**Diethylene Glycol Monohexyl Ether

The alkaline compositions were combined with 25 pounds of prepared film, including Kodak DryView™ X-ray film, in a Littleford Day FM-130 ploughshare type mixer available from the Littleford Day Company of Florence, Ky. The mixtures were run at 80 rpm for approximately 30 minutes at an internal mixer temperature of about 200° F. After 30 minutes, an air sparge was turned on in the mixer run for approximately 30 minutes, until the mixture was dry. The mixture was then removed from the mixture and vibrated over a screen. The separated dry coating materials were collected. The polyester substrate materials were then washed under agitation with a solution including 1% by weight sodium hydroxide and ½% by weight of a wetting agent of ethoxylated alcohol: Ethal DA-6 (POE6 Decyl Alcohol). Visual inspection of the washed polyester materials showed no evidence of remaining coatings on the polyester substrate.

A comparison alkaline composition was prepared containing water and 5% caustic soda w/w. This composition was mixed with prepared film, including Kodak DryView™ X-ray film, and processed in a manner similar to mixtures 1-4, above. Inspection of the recovered polyester showed individual flakes still coated with the X-ray film emulsions after processing.

### Example 2

The following alkaline compositions were prepared according to the present invention

| | Mix 1 | Mix 2 | Mix 3 | Mix 4 |
|---|---|---|---|---|
| Water (liters) | 3 | 3 | 3 | 3 |
| Caustic Soda (g) | 50 | | 50 | |
| Soda Ash (g) | | 70 | | 67 |
| Lime (g) | 50 | 50 | 50 | 50 |
| Hexyl Carbitol(g)** | | | 30 | 30 |
| Ethoxylated alcohol (g) | | | 30 | 30 |
| Tetramethyl | | | 5 | 5 |
| ammonium chloride (g) | | | | |

**Diethylene Glycol Monohexyl Ether

The alkaline compositions were combined with 500 grams of prepared film, including Kodak DryView™ X-ray film, in a 3 liter glass beaker. The mixtures were heated with agitation for approximately 30 minutes to a temperature of about 200° F. The mixtures were then maintained at 200° F. for an additional 30 minutes. The aqueous mixture was then removed from the beaker and vibrated over a screen. The polyester substrate materials were separated from the aqueous liquid containing the degraded coating materials. The polyester substrate materials were then rinsed with an additional 3 liters of water. Visual inspection of the washed polyester materials showed no evidence of remaining coatings on the polyester substrate.

A comparison alkaline composition was prepared similar in formulation to mix 3, with the exception that the lime was not added. This composition was mixed with prepared film, including Kodak DryView™ X-ray film, and processed in a manner similar to mixtures 1-4, above. Inspection of the recovered polyester showed individual flakes still coated with the X-ray film emulsions after processing.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A process for separating coating materials from an adhered polyester substrate comprising:
combining materials containing polyester adhered to a coating with an alkaline composition such that said alkaline composition coats at least a portion of said polyester materials, said alkaline composition comprising a Group I alkaline compound and a Group II alkaline compound; and
adding sufficient energy to said coated polyester materials to promote separation of said coating materials from the surface of said polyester substrate.

2. The process of claim 1, further comprising:
drying the resultant mixture comprising said polyester substrate and said separated coating materials; and
removing at least a portion of said dried coating materials from said dried polyester substrate through one or more dry separation techniques.

3. The process of claim 2, further comprising subjecting said dried polyester substrate to one or more washing operations.

4. The process of claim 1, wherein said polyester materials and said alkaline composition are combined in a high energy mixer capable of providing sufficient energy to said polyester materials to promote said separation.

5. The process of claim 4, wherein said mixer is heated to an internal temperature of about 200° F.

6. The process of claim 1, wherein said alkaline composition comprises:
a) water in an amount from about 8% to about 100% by weight of said polyester materials,
b) said Group I alkaline compound in an amount from about 0.3% to about 1.0% by weight of said polyester materials, and
c) said Group II alkaline compound in an amount from about 0.40% to about 0.55% by weight of said polyester materials.

7. The process of claim 6, wherein said Group I alkaline compound is a Group I metal hydroxide and is added in an amount from about 0.40% to about 0.55% by weight of said polyester materials.

8. The process of claim 6, wherein said Group I alkaline compound is a Group I metal carbonate compound added in an amount from about 0.55% and about 0.70% by weight of said polyester materials.

9. The process of claim 1, wherein said Group I alkaline compound is selected from the group consisting of sodium hydroxide, sodium carbonate, potassium hydroxide, and potassium carbonate.

10. The process of claim 1, wherein said Group II alkaline compound is selected from the group consisting of calcium hydroxide, calcium carbonate, magnesium carbonate, and magnesium hydroxide.

11. The process of claim 1, wherein said Group I alkaline compound is selected from the group consisting of sodium hydroxide and sodium carbonate, and said Group II alkaline compound is calcium hydroxide.

12. The process of claim 2, wherein said resultant mixture is dried within said mixer.

13. The process of claim 2, wherein said one or more dry separation techniques remove between about 50% and about 90% of said coating materials from said polyester.

14. The process of claim 2, wherein said dry separation techniques comprise passing said dried resultant mixture over a vibrating screen.

15. The process of claim 2, wherein said dry separation techniques comprise passing said dried resultant mixture through a cyclone.

16. The process of claim 1, wherein said coated polyester materials comprise polyester materials coated with digitally printed images.

17. A process for recovering silver from polyester substrate film coated with a silver-emulsion comprising:
combining said film with an alkaline composition in a mixer such that said alkaline composition coats at least a portion of said film, said alkaline composition comprising
a) water in an amount from about 8% to about 100% by weight of said film,
b) a Group I alkaline compound in an amount from about 0.3% to about 1.0% by weight of said film, and
c) a Group II alkaline compound in an amount from about 0.40% to about 0.55% by weight of said film;
adding sufficient energy to said coated film to promote separation between said silver-emulsion and said polyester substrate and to promote degradation of said silver-emulsion;
drying the resultant mixture comprising said polyester substrate and said degraded silver-emulsion; and
removing between about 50% and about 90% of said degraded silver-emulsion from said dried polyester substrate through one or more dry separation techniques.

18. The process of claim 17, further comprising smelting of said degraded silver-emulsion.

19. The process of claim 17, further comprising washing said polyester substrate such that said polyester substrate is at least about 99% pure.

20. The process of claim 19, wherein said polyester is washed with an alkaline solution comprising about 1% sodium hydroxide and water.

21. The process of claim 19, wherein said polyester is washed with a solution consisting essentially of water.

22. The process of claim 17, wherein said alkaline composition further comprises a surfactant.

23. The process of claim 17, wherein said mixer is a high energy mixer capable of providing sufficient energy to promote said separation.

24. The process of claim 23, wherein said mixer is heated to an internal temperature of about 200° F. during said separation.

25. The process of claim 17, wherein said Group I alkaline compound is a Group I metal hydroxide added in an amount from about 0.40% to about 0.55% by weight of said polyester materials.

26. The process of claim 17, wherein said Group I alkaline compound is a Group I metal carbonate added in an amount from about 0.55% to about 0.70% by weight of said polyester materials.

27. The process of claim 17, wherein said Group I alkaline compound is selected from the group consisting of sodium hydroxide and sodium carbonate, and said Group II alkaline compound is calcium hydroxide.

28. The process of claim 17, wherein said dry separation techniques comprise passing said dried resultant mixture over a vibrating screen.

29. The process of claim 17, wherein said dry separation techniques comprise passing said dried resultant mixture through a cyclone.

30. The process of claim 17, wherein said film comprises film coated with digitally printed images.

31. A composition for removing coatings from polyester materials comprising:
a) water in an amount from about 8% to about 100% by weight of said polyester materials,
b) a Group I alkaline compound in an amount from about 0.3% to about 1.0% by weight of said polyester materials, and
c) a Group II alkaline compound in an amount from about 0.40% to about 0.55% by weight of said polyester materials.

32. The composition of claim 31, wherein said Group I alkaline compound is a Group I metal hydroxide added in an amount from about 0.40% to about 0.55% by weight of said polyester materials.

33. The composition of claim 31, wherein said Group I alkaline compound is a Group I metal carbonate added in an amount from about 0.55% and about 0.70% by weight of said polyester materials.

34. The composition of claim 31, wherein said Group I alkaline compound is selected from the group consisting of sodium hydroxide, sodium carbonate, potassium hydroxide, and potassium carbonate.

35. The composition of claim 31, wherein said Group II alkaline compound is selected from the group consisting of calcium hydroxide, calcium carbonate, magnesium carbonate, and magnesium hydroxide.

36. The composition of claim 31, wherein said Group I alkaline compound is selected from the group consisting of sodium hydroxide and sodium carbonate, and said Group II alkaline compound is selected from the group consisting of calcium hydroxide and calcium carbonate.

37. The composition of claim 31, wherein said Group I alkaline compound is selected from the group consisting of sodium hydroxide and sodium carbonate, and said Group II alkaline compound is calcium hydroxide.

38. The composition of claim 31, wherein said coated polyester materials comprise polyester materials coated with digitally printed images.
